(19) United States
(12) Patent Application Publication
(10) Pub. No.: US 2016/0119649 A1
(43) Pub. Date: Apr. 28, 2016

(54) Device and Method for Processing Ultra High Definition (UHD) Video Data Using High Efficiency Video Coding (HEVC) Universal Decoder

(71) Applicant: PathPartner Technology Consulting Pvt. Ltd., Bangalore (IN)

(72) Inventors: Ramakrishna Adireddy, Bangalore (IN); Prashanth Nandalike Subramanya, Bangalore (IN); Rama Mohana Reddy, Bangalore (IN)

(73) Assignee: PATHPARTNER TECHNOLOGY CONSULTING PVT. LTD., Bangalore (IN)

(21) Appl. No.: 14/920,438

(22) Filed: Oct. 22, 2015

(30) Foreign Application Priority Data
Oct. 22, 2014 (IN) 5274/CHE/2014

(51) Int. Cl. H04N 19/70; H04N 19/117; H04N 19/119; H04N 19/124; H04N 19/13; H04N 19/159; H04N 19/593; H04N 19/61; H04N 19/14; H04N 19/44; H04N 19/137

(52) U.S. Cl. CPC H04N 19/70; H04N 19/44; H04N 19/117; H04N 19/119; H04N 19/124; H04N 19/137; H04N 19/159; H04N 19/593; H04N 19/61; H04N 19/14; H04N 19/13

(57) ABSTRACT

The present invention discloses a device and method for processing video data using HEVC universal decoder. The HEVC universal decoder is designed to address the parallel execution issues and bandwidth issues when there is a decoded data transfer among the processors. The decoder is designed to achieve better core utilization with reduced memory bandwidth. The decoder is designed to work in two partitions to obtain the decoded YUV pictures output from a bit-stream. The invention provides for reduction in the number of processors used in the first partition of the HEVC universal decoder without affecting the decoding rate of the bit-streams. In second partition, decoding of one data-frame is carried out simultaneously by four processors. Both the partitions complete their respective decoding processes in equal amount of time.

### PREAMBLE TO THE DESCRIPTION

The following specification particularly describes the invention and the manner in which it is to be performed:

### TECHNICAL FIELD OF THE INVENTION

The present invention relates to a device and method for processing video data using HEVC universal decoder.

### BACKGROUND OF THE INVENTION

In the present day market scenario, digital video products are in huge demand. Some examples of digital video products include DV (Digital Video) cameras, HDTV (High Definition Tele Vision), satellite TV (Tele Vision), set-top boxes, internet video streaming, digital cameras, cellular telephones, video jukeboxes, high-end displays, personal video recorders etc, which find applications in various fields such as video communication, security and surveillance, industrial automation, and entertainment etc. In these digital video products, the captured video is compressed into a coded video sequence through various video coding technologies. The main purpose of compressing the video sequence is to reduce the size of the video sequence in terms of bits. Many video coding standards have been developed and while some of them are still under development. Recent developments in video coding standardisation have led to the formation of a HEVC standard. The HEVC standard is developed by Joint Collaborative Team-Video Coding (JCT-VC) group.

Various types of conventional devices using HEVC decoder for decoding compressed video data are known in the prior art. The US Patent document. 2014307775 A1 describes method and device for partitioning an image. The claimed method and device defines partition of an image for transmission of one or more regions of interest of said image, the image being composed of coding units, the method comprising: performing a first partitioning of the image into one or more portions of coding units, wherein each portion is encodable or decodable without any coding dependency on another of the portions, a region of interest comprising at least one portion; and performing a second partitioning the image onto one or more segments of coding units comprising at least one independent segment which is encodable or decodable without any coding dependency on another of the segments and at least one dependent segment which is dependent on the independent segment for coding or decoding, the second partitioning being based on the portions of the first partitioning; wherein at least part of one of the portions is encoded in an independent segment and at least part of another of the portions is encoded in a dependent segment.

The US Patent document 2013107970 describes a transform unit partitioning for chroma components in video coding. A video encoding device is configured to obtain an N by N array of residual values for a luma component and a corresponding N/2 by N array of residual values for a chroma component. The video encoding device may partition the N/2 by N array of residual values for the chroma component into two N/2 by N/2 sub-arrays of chroma residual values. The video encoding device may further partition the sub-arrays of chroma residual values based on the partitioning of the array of residual values for the luma component. Video encoding device may perform a transform on each of the sub-arrays of chroma residual values to generate transform coefficients. A video decoding device may use data defining sub-arrays of transform coefficients to perform a reciprocal process to generate residual values.

The EP Patent document 2837186 describes method and apparatus for block partition of chroma sub sampling formats. The claimed method and apparatus defines video data processing for video in YUV422 or YUV 444 formats. In one embodiment, for a 2N×2N luma coding unit (CU) in YUV422 format, the transform process partitions residue data corresponding to the 2N×2N luma CU and the N×2N chroma CU into square luma and chroma transform units (TUs). The residue data associated with the luma and the chroma CUs are generated by applying prediction process to the luma CU and the chroma CU. The transform process is independent of prediction block size or prediction mode associated with the prediction process. In another embodiment, the prediction process splits the CU into two prediction blocks. Transform process is applied on the chroma residue data corresponding to the chroma CU to form one or more chroma TUs, wherein the transform process is dependent on CU size and prediction block size, or CU size and prediction mode.

However, the use of claimed devices and methods does not split the processors to operate the HEVC decoder into two or more partitions for decoding the video frames in order to achieve better core utilization with minimal inter-chip data transfer.

In conventional HEVC universal decoder, the solution for general video formats, (8-bits/pixel, 4:2:0 YUV) and High Definition (HD) (1920×1080) resolution support at 60 fps, are achieved on ARM Quad-core and also on Intel Xeon Quad-core platforms. Typically, the HEVC decoders are designed to use more number of such Quad-core chips to achieve real-time solution for professional video formats (10-bits/pixel, 4:2:2 YUV) and Ultra High Definition (UHD) (3840×2160) resolution support at 60 fps.

Ever increasing computation needs for digital video having higher & higher resolutions such as HD and UHD etc. make it unrealistic to carry out real-time video encoding or decoding on a single core system or a single multi-core system. Conventional systems make use of multi-core processors for real-time video decoding along with UHD support. For UHD, single multi-core system may not be good enough for achieving real time performance. Currently, the multi-core processors contain dual (2)/Quad (4)/Octal (8) cores.

Designing video decoders on multi-chip systems face two main challenges: the first challenge is encountered due to the usage of block based processing with tight spatial and temporal dependencies in video compression that causes difficulty in creating independent tasks. The second challenge is encountered due to the requirement of larger data structures for higher resolution data and also corresponding increase in the necessary memory bandwidth requirements for data exchange between chips in multi-chip scenario.

In the context of multi-core and/or multi-chip decoders, designing a HEVC universal decoder is the most challenging task. In this type of decoder, the performance of multi-chip video decoder solution would depend not only on program execution, but also on memory band-width and data access patterns.

Hence, there is need for a device and method to operate the HEVC universal decoder in two partitions and is designed to achieve better core utilization with minimal inter-chip data transfer for decoding the video data.

### SUMMARY OF THE INVENTION

The present invention overcomes the drawbacks in the prior art and provides a device for processing Ultra High Definition (UHD) video data using High Efficiency Video Coding (HEVC) decoder. The device comprises of one or more processors arranged into at-least two partitions. The two partitions are configured to operate the HEVC decoder using two phases for decoding process. The first phase of HEVC decoder operates for the first partition and the second phase of HEVC decoder operates for the second partition. A plurality of video frames received from the overhead information is decoded in the first partition using the first phase of HEVC decoder. The first partition uses only single processor to decode the single video frame using the first phase of HEVC decoder. The second partition receives the decoded video frames from the first partition. The second partition decodes and stores the decoded video frames using the second phase of HEVC decoder, wherein the second partition uses the multiple processors to decode and store the decoded single video frame using the second phase of HEVC decoder.

In a preferred embodiment of the invention, the first phase of HEVC decoder includes an entropy decoding module or Context-adaptive binary arithmetic coding (CABAC), an inverse quantization and inverse transform, an edge detection and boundary strength calculation for de-blocking purpose, an optimal DDR bandwidth algorithm to consider overlap of reference regions and a Decoded Picture Buffer (DPB) module.

In a preferred embodiment of the invention, the second phase of HEVC decoder includes an intra prediction module, motion compensation module, a reconstruction module, a de-blocking filtering module and an SAO module.

In a preferred embodiment of the invention, the HEVC decoder is designed to carry out equal amount of load balance in both first partition and second partition for processing the decoded video frame to achieve better core utilization with reduced memory bandwidth.

According to another embodiment of the invention, the invention provides a method for processing UHD video data using HEVC decoder. In most preferred embodiment, the method includes the step of arranging one or more processors into two partitions, wherein the two partitions are configured to operate the HEVC universal decoder into two phases for decoding process. After arranging the processors into two partitions, the video frames are obtained from the overhead information. The obtained video frames are decoded in the first partition using the first phase of HEVC universal decoder. The first partition uses only single processor to decode the single video frame using the first phase of HEVC decoder. After decoding the video frames in the first partition, the decoded video frames are transferred to the second partition. Finally, the transferred decoded video frames are further decoded and stored in the second partition using the second phase of HEVC decoder. The second partition uses the multiple processors to reconstruct and store the uncompressed single video frame using the second phase of HEVC decoder.

The present invention has been designed to have very low data transfer between the chips which results in memory and power saving in the HEVC universal decoder. The invented decoder is designed to work for larger bit-rates with no constraints. Moreover, the temporal dependencies between the chips in HEVC universal decoder are reduced. The invented decoder is capable of accommodating any Group of Pictures (GOP) structure and it can be even applied for multi-cores of a chip in the HEVC universal decoder.

The present invention provides a device which is simple, time saving, resource efficient, and cost effective. The invention may be used in digital image capture units such as digital video cameras, HDTV, satellite TV, set-top boxes, internet video streaming, digital cameras, cellular telephones, video jukeboxes, high-end displays, personal video and recorders etc.

It is to be understood that both the foregoing general description and the following details description are exemplary and explanatory and are intended to provide further explanation of the invention as claimed.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 illustrates a block diagram of the HEVC universal decoder, according to one embodiment of the invention.

FIG. 2 illustrates the method for implementing UHD Main-10 4:2:2 HEVC universal decoder on eight chips or processors, according to one embodiment of the invention.

FIG. 3 illustrates the method for implementing UHD Main-10 4:2:2 HEVC universal decoder on six chips or processors, according to one embodiment of the invention.

FIG. 4 illustrates the method flow involved in implementing HEVC universal decoder on multi-processors, according to one embodiment of the invention.

FIG. 5 illustrates the table representing the tasks performed on each chip at different time slots at the steady state, according to one embodiment of the invention

### DETAILED DESCRIPTION OF THE INVENTION

Reference will now be made in detail to the description of the present subject matter, one or more examples of which are shown in figures. Each embodiment is provided to explain the subject matter and not a limitation. These embodiments are described in sufficient detail to enable a person skilled in the art to practice the invention, and it is to be understood that other embodiments may be utilized and that logical, physical, and other changes may be made within the scope of the embodiments. The following detailed description is, therefore, not be taken as limiting the scope of the invention, but instead the invention is to be defined by the appended claims.

The present invention discloses a device and method for processing video data using an HEVC universal decoder that is designed to address the parallel execution issues and bandwidth issues when there is a decoded data transfer among the processors. The decoder is designed to achieve better core utilization with reduced memory bandwidth. The decoder is designed to work in two partitions to obtain the decoded YUV picture output from a bit-stream. The invention allows the reduction in the number of processors used in the first partition of the HEVC universal decoder without affecting the decoding rate of the bit-streams. In second partition, decoding of one data-frame is carried out simultaneously by four processors/cores. The decoder is designed to carry out equal amount of load balance in both first partition and second partition. Both the partitions complete their respective decoding processes in an equal amount of time.

The present invention has been designed to have very low data transfer between the chips which results in memory and power saving in the HEVC universal decoder. The invented decoder is designed to work for larger bit-rates without any constraints. Moreover, the temporal dependencies between the chips in HEVC universal decoder are reduced. The invented decoder is capable of accommodating any GOP structure and it can be even applied for multi-cores of a chip in the HEVC universal decoder.

The present invention provides a device which is simple, saves time, resource efficient and cost effective. The device may be used in digital image capture units such as digital video cameras, HDTV, satellite TV, set-top boxes, internet video streaming, digital cameras, cellular telephones, video jukeboxes, high-end displays, personal video and recorders etc.

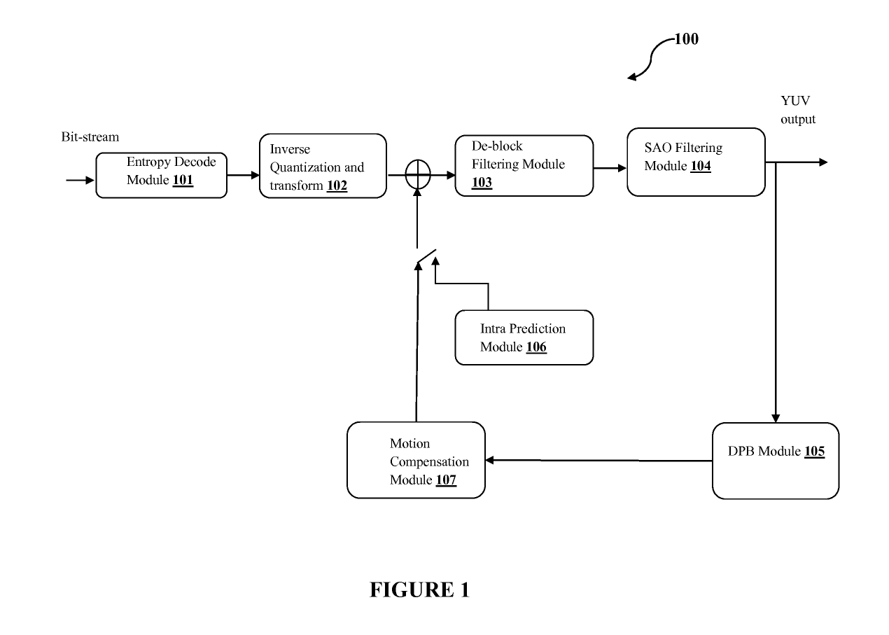

FIG. 1 illustrates a block diagram of the HEVC universal decoder, according to one embodiment of the invention. The HEVC universal decoder 100 comprises of a entropy decode module 101 or Context-Adaptive Binary Arithmetic Coding (CABAC), a inverse quantization module 102, an inverse transform module 102, a de-block filtering module 103, a Sample Adaptive Offset (SAO) filtering module 104, a Decoded Picture Buffer (DPB) module 105, a motion compensation module 107 and an intra prediction module 106. The HEVC universal decoder 100 receives a bit-stream (e.g. one or more coded pictures included in the bit-stream) for decoding. The bit-stream is obtained from overhead information such as received slice header, received PPS (Picture Parameter Set), received buffer description information, classification indicator, etc. The received bit-stream is entropy decoded by the entropy decoding module 101 to produce a motion information signal and intra prediction information with decoded residual signal i.e., TQC (Transformed Quantized Coefficients). The motion information signal is combined with a portion of a decoded picture from a DPB module 105 and a motion compensation module 107 produce a prediction signal. The prediction signal is added to a summation module to produce a combined signal. The prediction signal may be a signal selected from either the inter-frame prediction signal produced by the motion compensation module 107 or an intra-frame prediction signal produced by an intra-frame prediction module 106. This prediction signal selection is based on the input bit-stream. This combined signal is filtered by a de-blocking filter module 103. The resulting filtered signal is provided to a SAO module 104. Based on the filtered signal and information from the entropy decoding module 101, the SAO module 104 may produce an SAO signal that is provided to a DPB module. The DPB module 105 may include decoded data from one or more pictures that may be used as reference or dependency pictures. The DPB module 105 also includes overhead information corresponding to the decoded pictures. The DPB module 105 provides one or more decoded pictures to the motion compensation module 107. Furthermore, the DPB module 105 provides one or more decoded pictures, which may be output from the HEVC universal decoder 100. The one or more decoded pictures are presented on a display, stored in memory or transmitted to another device. The decoded picture consists of two chroma components and a luma component.

In further embodiments of the invention, the HEVC universal decoder 100 modules are designed to work in two partitions 201 and 202 to obtain the decoded YUV pictures output through the bit-stream. In the present invention, the HEVC universal decoder 100 is designed to categorize entire HEVC decoder functionality into two partitions. The first partition 201 includes an entropy decoding module 101 or CABAC, an Inverse Quantization & Inverse Transform 102 and a DPB module 105. The second partition 102 includes an intra prediction module 106, motion compensation module 107, a reconstruction module, a de-blocking filtering module 103 and an SAO module 104. The decoder 100 is designed to address the parallel execution issues and bandwidth issues which arise during a decoded data transfer among processors and/or chips. It is designed in such a way that no task in the first partition 201 has temporal dependency, but the second partition 202 has either direct or indirect temporal dependency. At steady state, it is observed that the first partition 201 and second partition 202 have equal complexity for moderate bit-rates. The decoder 100 is designed to achieve better core utilization with reduced memory bandwidth.

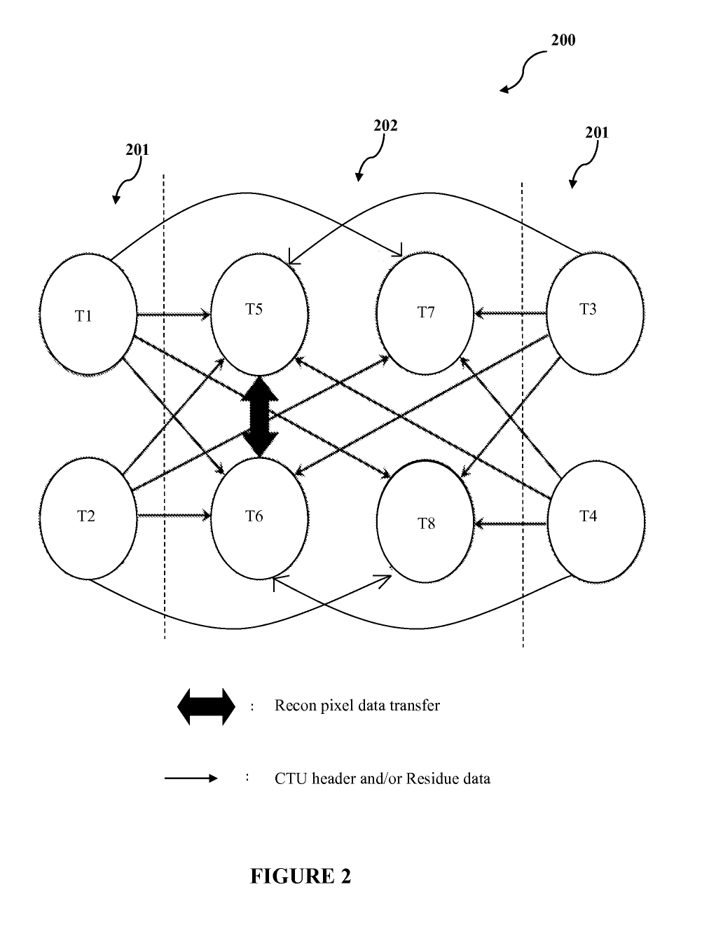

FIG. 2 illustrates the method for implementing UHD Main-10 4:2:2 HEVC universal decoder on eight chips or processors or cores, according to one embodiment of the invention. In this embodiment, the UHD Main-10 4:2:2 decoder 100 comprises of eight chips for processing the bit-streams or data-frames. The bit-stream or data-frame consists of a luma component (Y) and two chroma components (Cb and Cr).

Further, the luma component (Y) is partitioned into an upper half luma frame (Y1) and a lower half luma frame (Y2). The eight chips are T1, T2, T3, T4, T5, T6, T7 and T8. The 4:2:2 HEVC universal decoder 100 is designed to work in two partitions. The first partition 201 is executed on T1, T2, T3 and T4 chips. The second partition 202 is executed on T5, T6, T7 and T8 chips. In the first partition 201 which has four chips, four different frames are decoded in parallel. Simultaneously, the second partition 202 having T5, T6, T7 and T8 chips executes and decodes single video frame which it receives from the first partition 201. Each chip or processor of the second partition works on different color components Y1, Y2, Cb and Cr. In this method, the second partition may execute four times faster than first partition which compensates first partition working on 4 different video frames simultaneously.

In first partition 201, one video frame is decoded by only one chip. But, in second partition 202 one video frame (where one data-frame includes Y1, Y2, Cb and Cr components) is decoded simultaneously by four-chips. The second partition 202 is designed such that, Y1 is decoded and stored in T5 chip, Y2 is decoded and stored in T6 chip, Cb is decoded and stored in T7 chip and Cr is decoded and stored in T8 chip. There is a bi-directional luma pixel (Y1 and Y2) data transfer between the T5 chip and T6 chip. The second partition 202 starts only after the first partition 201. Since, the second partition 202 tasks start only after the first partition 201, there will be initial delay (pipe-up delay) in the second partition 202.

As a result of the above process, there is approximately equal load balance between the first partition 201 and the second partition 202. One complete video frame operations in second partition 202 gets over in time (T/4) ms. The first partition 201 operations will get completed only for quarter of the video frame in the same time i.e., (T/4) ms, by a single chip. As four chips are executing in first partition 201 in parallel for four video frames, they altogether effectively complete one video frame's amount of data in (T/4) ms. Thus, all eight chips complete decoding process of four video frames in “T” ms.

Considering above 4:2:2 chroma sub-sampling, it can be observed that the two partitions have approximately equal computational needs, where each of them performs same operations for equal amount of pixels. The key advantage of splitting second partition 202 tasks into four independent tasks and running them in parallel on different processors is that the reference video frame data, data management and corresponding transfers can be avoided among the chips or processors.

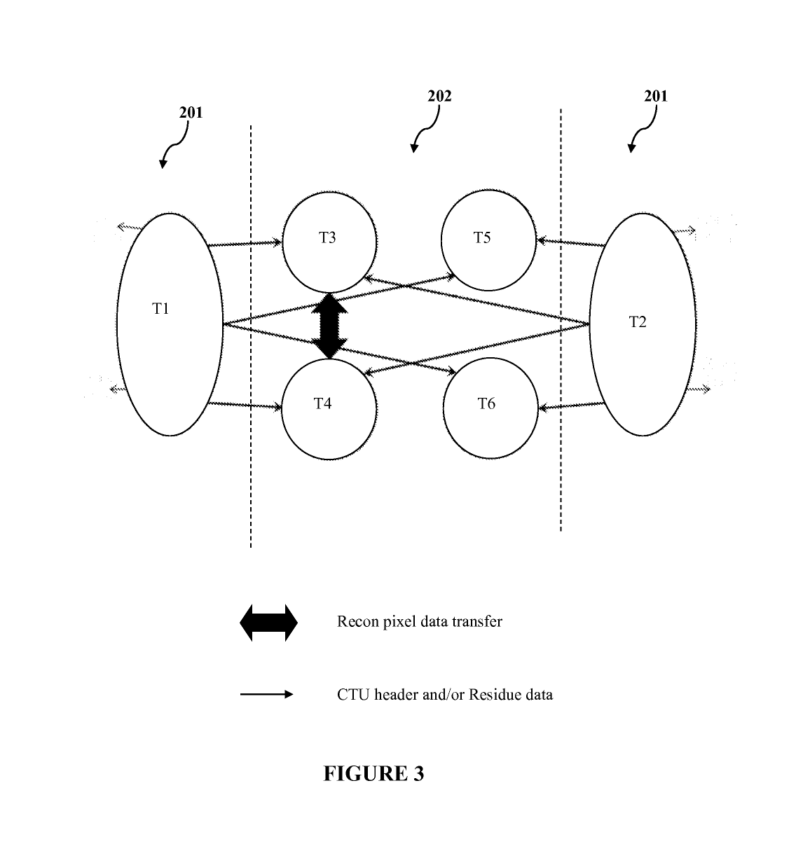

FIG. 3 illustrates the method for implementing six chips or processors for a HEVC universal decoder, according to one embodiment of the invention. In the method for implementing six chips or processors, the first partition of the HEVC universal decoder 100 is designed such that the operations for a bit-stream get executed by half the cores of a chip/processor. That way, two chips are good enough to carry out the first partition 201 operations for four frames in parallel. And remaining four-chips perform the second partition 202 operations.

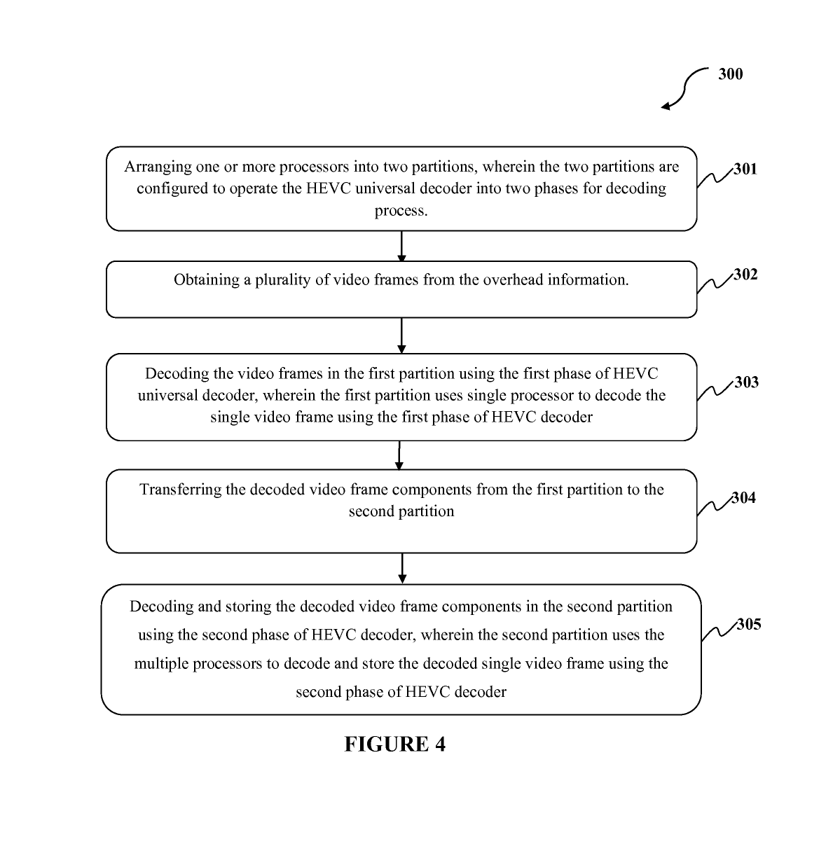

FIG. 4 illustrates the method flow 300 involved in implementing the multi-processors for a HEVC universal decoder, according to one embodiment of the invention. At step 301, the processors are arranged into two partitions. The two partitions are configured to operate the HEVC universal decoder into two phases for decoding process. After arranging the processors into two partitions, at step 302, the bit-streams or video frames are obtained from the overhead information. At step 303, the obtained video frames are decoded in the first partition using the first phase of HEVC universal decoder. The first partition uses only single processor to decode the single video frame using the first phase of HEVC decoder. After decoding the video frames in the first partition, at step 304, the decoded bit-stream components from the first partition are transferred to the second partition of the HEVC universal decoder. Finally, at step 305 the transferred decoded video frames are further decoded and stored in the second partition using the second phase of HEVC decoder. The second partition uses the multiple processors to decode and store the decoded single video frame using the second phase of HEVC decoder.

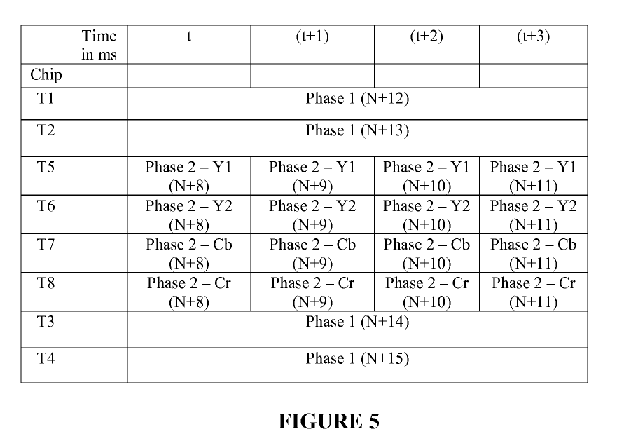

FIG. 5 illustrates the table representing the tasks performed on each chip at different time slots at the steady state, according to one embodiment of the invention. At the start of operation, the first partition operates for first four frames on four chips (T1, T2, T3 and T4) and remaining four chips (T5, T6, T7 and T8) will be idle. As the decode operation reaches the steady state, all eight chips get occupied as shown. The column in the table represents different chip/core and rows represent the time. The total time needed to decode all four frames is divided into four parts as t, (t+1), (t+2), (t+3). From the table, it is observed that, the chips T1, T2, T3 and T4 are working for four different frames (N+12), (N+13), (N+14), (N+15) individually. At the same time, the chips T5, T6, T7 and T8 work for second partition of frames (N+8) at time (t) in parallel and similarly for frame (N+9) at time (t+1), for frame (N+10) at time (t+2) and for frame (N+11) at time (t+3).

The present invention provides a device which is simple, time saving, resource efficient, and cost effective. The invention may be used in digital image capture units such as digital video cameras, HDTV, satellite TV, set-top boxes, Internet video streaming, digital cameras, cellular telephones, video jukeboxes, high-end displays, personal video and recorders etc.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

We claim:

1. A device for processing Ultra High Definition (UHD) video data using High Efficiency Video Coding (HEVC) decoder, the device comprises of:
a. one or more processors arranged into at-least two partitions, wherein the two partitions are configured to operate the HEVC decoder using into two phases for decoding process;
b. the first phase of HEVC decoder operates for the first partition and the second phase of HEVC decoder operates for the second partition;
c. a plurality of video frames received from the overhead information is decoded in the first partition using the first phase of HEVC decoder, wherein the first partition uses single processor to decode the single video frame using the first phase of HEVC decoder; and
d. the second partition receives the decoded video frames from the first partition, wherein the second partition decodes and stores the decoded video frames using the second phase of HEVC decoder, wherein the second partition uses the multiple processors to decode and store the decoded single video frame using the second phase of HEVC decoder.

2. The device as claimed in claim 1, wherein the first phase of HEVC decoder includes an entropy decoding module or CABAC, an inverse quantization and inverse transform an edge detection and boundary strength calculation for de-blocking purpose, an optimal DDR bandwidth algorithm to consider overlap of reference regions and a DPB module.

3. The device as claimed in claim 1, wherein the second phase of HEVC decoder includes an intra prediction module, motion compensation module, a reconstruction module, a de-blocking filtering module and an SAO module.

4. The device as claimed in claim 1, wherein the HEVC decoder is designed to carry out equal amount of load balance in both first partition and second partition for processing the decoded video frame to achieve better core utilization with reduced memory bandwidth.

5. The device as claimed in claim 1, wherein the second partition is divided based on color components in the video frames.

6. A method for processing Ultra High Definition (UHD) video data using High Efficiency Video Coding (HEVC) universal decoder, the method comprising the steps of:
a. arranging one or more processors into two partitions, wherein the two partitions are configured to operate the HEVC universal decoder into two phases for decoding process;
b. obtaining a plurality of video frames from the overhead information;
c. decoding the video frames in the first partition using the first phase of HEVC universal decoder, wherein the first partition uses single processor to decode the single video frame using the first phase of HEVC decoder;
d. transferring the decoded video frame components from the first partition to the second partition; and
e. decoding and storing the decoded video frame components in the second partition using the second phase of HEVC decoder, wherein the second partition uses the multiple processors to decode and store the decoded single video frame using the second phase of HEVC decoder.
